(19) United States
(12) Patent Application Publication
(10) Pub. No.: US 2013/0217291 A1
(43) Pub. Date: Aug. 22, 2013

(54) METHOD FOR DISASSEMBLING PLASMA DISPLAY DEVICE

(71) Applicant: Panasonic Corporation, (US)

(72) Inventor: Tetsuro Ozawa, Osaka (JP)

(73) Assignee: Panasonic Corporation, Osaka (JP)

(21) Appl. No.: 13/847,128

(22) Filed: Mar. 19, 2013

Related U.S. Application Data
(63) Continuation of application No. PCT/JP2012/002668, filed on Apr. 18, 2012.

(30) Foreign Application Priority Data
Sep. 1, 2011 (JP) 2011-190299

(51) Int. Cl. H01J 9/52

(52) U.S. Cl. CPC H01J 9/52
USPC 445/24

(57) ABSTRACT

The present disclosure relates to a method for disassembling a plasma display device including PDP (11) hating front plate (20) and rear plate (21), and metal support plate (14) bonded to rear plate (21) of PDP (11) with bonding member (16) interposed therebetween. The method includes performing irradiating with infrared rays from a side of front plate (20) constituting PDP (11), to heat bonding member (16) between PDP (11) and metal support plate (14) so as to decrease bonding strength, and thereafter to separate PDP (11) and metal support plate (14).

### TECHNICAL FIELD

The present disclosure relates to a method for disassembling a plasma display device.

### BACKGROUND ART

In recent years, as an image display device appropriate for slimming and upsizing, a plasma display device using a plasma display panel (hereinafter referred to as a PDP) has been mass-produced and rapidly diffused.

The PDP is mounted on a display section of the plasma display device. The PDP is configured by a front plate formed with a display electrode, a dielectric layer, a protective layer and the like on a glass substrate, and a rear plate formed with an address electrode, a barrier rib, a phosphor layer and the like on a glass substrate. The front plate and the rear plate are arranged as opposed to each other so as to form a minute discharge space between. both substrates, and peripheral edges of both substrates are sealed by fit glass. A discharge space is sealed. with a discharge gas formed by mixing inert gases such as a neon gas (Ne) and a xenon (Xe) gas.

A metal support plate as a chassis member is pasted to the rear surface of the rear plate of the PDP with an adhesive joint member such as a thermal conduction sheet interposed therebetween. The metal support plate has a function as the chassis member as well as a function as a heat sink. The chassis member is used. to be attached with a circuit board for driving the PDP, and the heat sink is used to efficiently dissipate heat generated by driving the PDP. Further, the plasma display device is mounted with a front frame and a back cover for protecting the PDP and the circuit board.

Incidentally, with the rapid diffusion of plasma display devices in recent years, the number of used and waste plasma display devices is on the rapid increase. Moreover, with increase in production amount of plasma display devices, the absolute number of defective PDP units in a manufacturing process is also on the increase. Accordingly, from viewpoints of environmental issues and resource savings, it is becoming important to develop and introduce a technique of disassembling the used and waste plasma display device or the defective PDP unit generated in the manufacturing process so as to recycle members or reproduce them as raw materials.

Disassembling the plasma display device into a recyclable form requires separation of the PDP, the metal support plate and the circuit board. Thereat, a variety of methods for separating the PDP unit have hitherto been proposed. For example, there has been proposed a method of heating the surface of a PDP by a hot plate to decrease bonding strength of a bonding member bonding the PDP and the metal support plate, so as to peel the PDP and the metal support plate from the bonding member (refer to PTL 1, for example).

For disassembling the plasma display device into a recyclable form, the plasma display device is collected to a disassembly plant. However, the number of disassembly plants for plasma display devices has hardly been changed with respect to the increase in number of disassembly processing on plasma display devices, and hence the number of disassembly processing per plant is on the increase. There has thus been a challenge to increase disassembly processing ability of the disassembly plant.

### CITATION LIST

### Patent Literature

PTL1: Unexamined Japanese Patent Publication. No. 2005-116346

### SUMMARY

The present disclosure relates to a method for disassembling a plasma display device including a plasma display panel having a front plate and a rear plate, and a metal support plate bonded to the rear plate of the plasma display panel with a bonding member interposed therebetween. The method includes irradiating with infrared rays from a side of the front plate constituting the plasma display panel, to heat the bonding member between the plasma display panel and the metal support plate so as to decrease bonding strength, and thereafter to separate the plasma display panel and the metal support plate.

### BRIEF DESCRIPTION OF DRAWINGS

FIG. 1 is an exploded. perspective view of a plasma display device in an embodiment of the present disclosure.

FIG. 2 is a sectional view of a PDP unit in the embodiment of the present disclosure.

FIG. 3 is a flowchart explaining disassembly of the plasma display device in the embodiment of the present disclosure.

FIG. 4 is a sectional view showing a status of use of a disassembly device in the embodiment of the present disclosure.

### DESCRIPTION OF EMBODIMENT

Hereinafter, an embodiment of the present disclosure will be described with reference to the drawings.

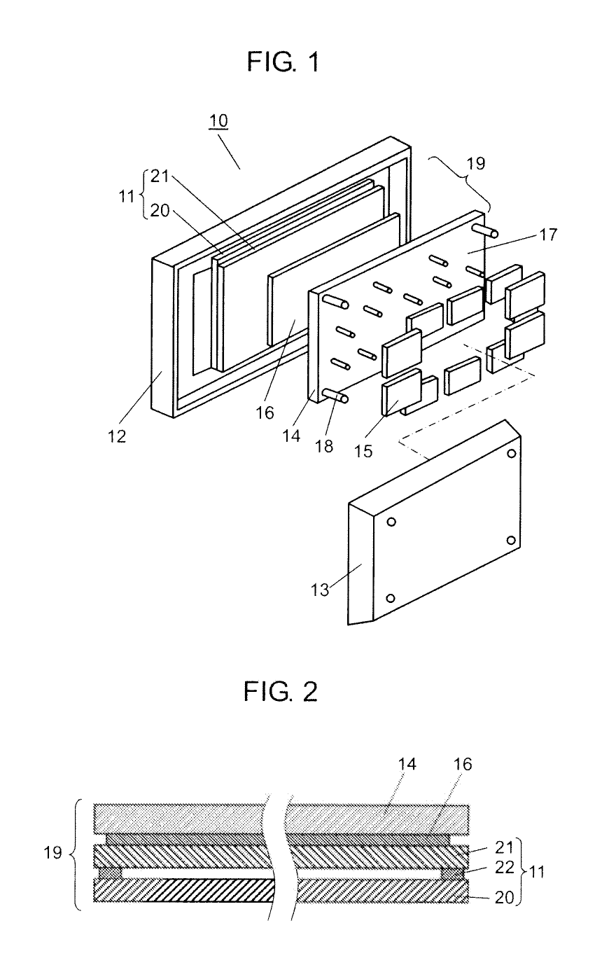

FIG. 1 is an exploded. perspective view of a plasma display device in an embodiment of the present disclosure, and FIG. 2 is a sectional view of a PDP unit in the present disclosure.

In FIG. 1, plasma display device 10 is provided with PDP 11 and a housing where this PDP 11 is housed. The housing is configured by combining front frame 12 and back cover 13. Between front frame 12 and back cover 13, metal support plate 14, circuit board 15 and bonding member 16 are arranged. Metal support plate 14 is configured by a metal plate made of aluminum or the like as a material, and also serves as a heat sink. Circuit board 15 is attached to metal support plate 14, and has a drive circuit for driving PDP 11. Bonding member 16 is a thermally conductive bonding sheet, and arranged between PDP 11 and metal support plate 14 to bond PDP 11 and metal support plate 14, while conducting heat generated from PDP 11 to metal support plate 14. Further, metal support plate 14 is provided with attachment 18 such as a fixing pin on attached surface 17 opposed to back cover 13. Back cover 13 and circuit board 15 are fixed by means of this attachment 18. As thus described, plasma display device 10 is arranged with PDP 11 bonded with bonding member 16 interposed therebetween, and PDP unit 19 including metal support plate 14.

Next, a detailed structure of PDP unit 19 will be described using FIG. 2. PDP unit 19 has PDP 11 and metal support plate 14 which are bonded with bonding member 16 interposed therebetween. PDP 11 is configured by front plate 20 and rear plate 21 that are made of glass with a thickness of 1.8 mm to 2.8 mm, and peripheral edges thereof are joined by sealing member 22 such as frit glass. Bonding member 16 is a thermally conductive bonding sheet applied with a bonding agent on both surfaces thereof. Bonding member 16 is arranged almost over rear plate 21 and metal support plate 14, and bonded with rear plate 21 and metal support plate 14. Bonding member 16 transfers heat, generated at the time of driving PDP 11, to metal support plate 14 and suppresses temperature rises of front plate 20 and rear plate 21 at the time of driving PDP 11. This can reduce thermal expansion of front plate 20 and rear plate 21 due to the temperature rise, so as to prevent, cracking and image deterioration of PDP 11.

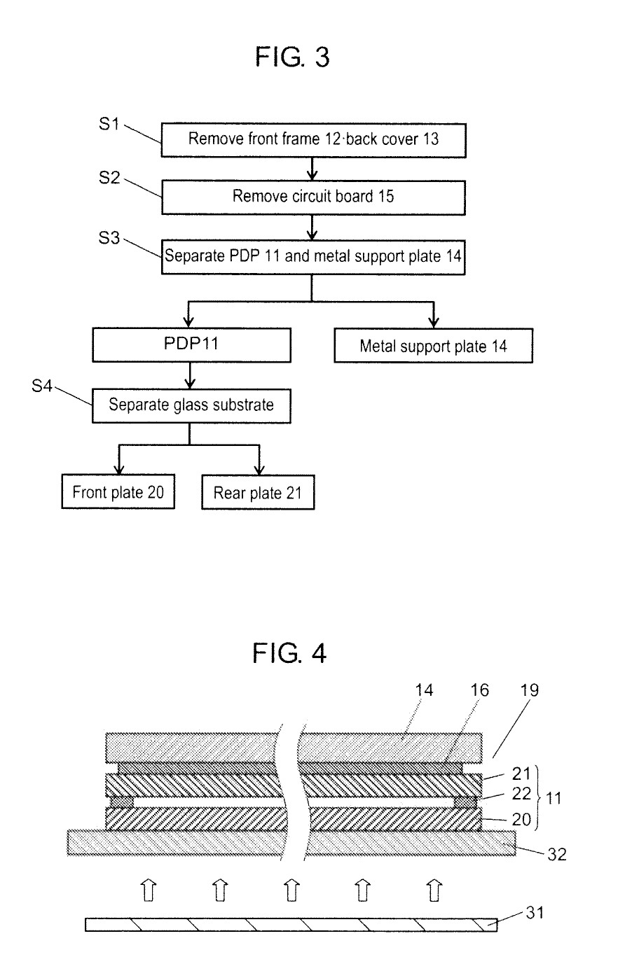

Next, a method for disassembling plasma display device 10 will be described using FIGS. 3 and 4.

As shown in FIG. 3, first, front frame 12 and back cover 13 are removed from plasma display device 10 (S1).

Next, circuit board 15 is removed from metal support plate 14 of PDP unit 19 (S2).

Next, as for PDP unit 19, bonding member 16 is heated by infrared-ray irradiation to reduce bonding strength, thereby separating PDP 11 and metal support plate 14 (S3).

Then, front plate 20 and rear plate 21 constituting PDP 11 are separated (S4). Constituents such as an electrode and a dielectric formed in each of glass substrates constituting front plate 20 and rear plate 21 are removed, and thereafter, the glass substrates are subjected to dissolution treatment or the like, so as to be recycled as glass materials.

FIG. 4 is a schematic view explaining the process of separating PDP 11 and metal support plate 14 (S3). As shown in FIG. 4, PDP unit 19 is disassembled by use of a disassembly device having infrared ray emitting section 31 and support 32. This disassembly device has infrared ray emitting section 31 for irradiating PDP unit 19 with infrared rays and support 32 for placing PDP unit 19 thereon. PDP unit 19 is placed on support 32 so as to be irradiated with infrared rays from a side of front plate 20 of PDP 11. Support 32 of the disassembly device is desirably configured by heat resistance glass such as quartz glass, or ceramic glass, which has a thermal expansion coefficient close to zero, and through which infra red rays are transmitted, and in the present embodiment, ceramic glass was used. Further, the distance from infrared ray emitting section 31 to PDP 11 placed on support 32 was 40 mm, and as infrared rays emitted from infrared ray emitting section 31, infrared rays with a peak wavelength of 1.2 μm and an output of 3.5 W/cm² were used.

Next, a method at the time of separating DP 11 and metal support plate 14 will be described in detail. First, a heater (not shown) of infrared ray emitting section 31 is energized in a state where PDP unit 19 is placed on support 32 such that the side of front plate 20 of PDP 11 is opposed to infrared ray emitting section 31.

Infrared rays emitted from infrared ray emitting section 31 are transmitted through support 32, and PDP 11 is irradiated with the infrared rays. Front plate 20 of PDP 11 has a structure including a display electrode, a dielectric layer, a protective layer and the like on the glass substrate, but since about 85% thereof is transparent, most of the infrared rays, with which the irradiation was performed, are transmitted through front plate 20. Since the electrode, phosphor and the like are applied to all over rear plate 21, about 30% of the infrared rays, with which the irradiation was performed, is transmitted, but the rest thereof is all absorbed in rear plate 21. Due to this absorption, a temperature of rear plate 21 suddenly rises, and simultaneously, bonding member 16 tightly joined with rear plate 21 is also rapidly heated. This bonding member 16 is rapidly heated by direct heating by infrared rays and thermal conduction from rear plate 21.

As thus described, when bonding member 16 is rapidly heated to a temperature at which its bonding strength decreases, for example to a temperature of about 200 degrees, the bonding strength of bonding member 16 decreases, thereby allowing peeling of PDP 11 and metal support plate 14 in a short time.

Herein, for confirming the range of an effective peak wavelength in infrared heating, a peak wavelength of infrared rays used for heating was changed, to measure the time until the temperature of bonding member 16 reached 200 degrees. Table 1 shows this result.

TABLE 1

| Infrared ray peak wavelength | Time until 200° C. were reached | |
|---|---|---|
| 1.2 μm | 3.5 | min. |
| 2.6 μm | 6 | min. |
| 3.0 μm | 10 | min. |
| 4.0 μm | 21 | min. |

As shown in Table 1, as the infrared ray peak wavelength is longer, the temperature of bonding member 16 reaches 200 degrees tends to be longer, and when the peak wavelength exceeds 3.0 μm, the time not shorter than 10 minutes is required. The shorter the time required for separating PDP 11 and metal support plate 14, the better it is, and considering a tact time in a disassembly plant, it is desirable to use infrared rays with its peak wavelength being in the range of the order of 1 μm to 3 μm.

Further, the distance between. infrared ray emitting section −and PDP 11 may be set such that an energy distribution of infrared rays, with which irradiation was performed, becomes uniform at the time of the infrared rays reaching front plate 20.

Moreover, although the disassembly method of placing PDP 11 on support 32 configured by glass or the like which transmits infrared rays and irradiating it with infrared rays from the lower side has been described in the present embodiment, another disassembly method may be applied. For example, a similar effect can be obtained when PDP 11 is arranged on support 32 such that infrared ray emitting section 31 and front plate 20 of PDP 11 are positioned in a mutually opposed manner and irradiation is performed with infrared rays in a state where PDP 11 and infrared ray emitting section 31 are erected (arrangement made by rotating the structure of FIG. 4 by 90 degrees).

As thus described, according to the present embodiment, it is possible to easily separate PDP 11 and metal support plate 14 in a short time. It is thereby possible to efficiently disassemble used plasma display device 10 and defective plasma display device 10 generated in a manufacturing process step.

Further, since infrared heating is performed by thermal radiation, PDP 11 and infrared ray emitting section 31 may be placed with an arbitrary distance held therebetween, and front plate 20 constituting PDP 11 and infrared ray emitting section 31 are not necessarily brought into close contact with each other.

Moreover, to deal with upsizing of facilities, an area of infrared ray emitting section 31 may be increased by adding the number of infrared heaters, thereby facilitating upsizing of the device.

### INDUSTRIAL APPLICABILITY

The present disclosure is useful in efficiently disassembling a used plasma display device and a defective plasma display device generated in a manufacturing process step.

### REFERENCE MARKS IN THE DRAWINGS

10 plasma display device
11 PDP
12 front frame
13 back cover
14 metal support plate
15 circuit board
16 bonding member
19 PDP unit
20 front plate
21 rear plate
22 sealing member
31 infrared ray emitting section
32 support

1. A method for disassembling a plasma display device,
the plasma display device including:
a plasma display panel having a front plate and a rear plate; and
a metal support plate bonded to the rear plate of the plasma display panel with a bonding member interposed therebetween,
the method comprising:
performing irradiation with infrared rays only from a side of the front plate constituting the plasma display panel, to heat the bonding member between the plasma display panel and the metal support plate so as to decrease bonding strength; and
thereafter separating the plasma display panel and the metal. support plate, wherein
a peak wavelength of infrared rays is from 1 μm to 3 μm.
